(19) United States
(12) Patent Application Publication
(10) Pub. No.: US 2026/0281039 A1
(43) Pub. Date: Sep. 17, 2026

(54) WIRELINE ACCESS-BASED CONGESTION PROCESSING METHOD AND APPARATUS, READABLE MEDIUM, AND DEVICE

(71) Applicant: Tencent Technology (Shenzhen) Company Limited, Shenzhen (CN)

(72) Inventor: Yixue LEI, Shenzhen (CN)

(21) Appl. No.: 19/672,538

(22) Filed: May 8, 2026

Related U.S. Application Data
(63) Continuation of application No. PCT/CN2024/133615, filed on Nov. 21, 2024.

(30) Foreign Application Priority Data
Dec. 28, 2023 (CN) 202311843740.7

(51) Int. Cl. H04L 47/11; H04W 28/02

(52) U.S. Cl. CPC H04L 47/115; H04W 28/0284

(57) ABSTRACT

Embodiments of this application provide a wireline access-based congestion processing method performed by a computer device acting as a residential gateway between a service processing device and a wireline access gateway device, and the method includes: establishing a protocol data unit PDU session with a core network element through the wireline access gateway device; monitoring a service data packet that is transmitted between the service processing device and a service server based on the PDU session; and when the service data packet transmitted between the service processing device and the service server experiences congestion, performing congestion marking processing. In the technical solutions in the embodiments of this application, the service processing device can implement congestion processing of a service data flow through both a 3GPP RAT and a non-3GPP RAT and improve utilization and service processing quality of a network bandwidth.

### CROSS-REFERENCE TO RELATED APPLICATIONS

This application is a continuation application of PCT Patent Application No. PCT/CN2024/133615, entitled “WIRELINE ACCESS-BASED CONGESTION PROCESSING METHOD AND APPARATUS, READABLE MEDIUM, AND DEVICE” filed on November 21, 2024, which claims priority to Chinese Patent Application No. 202311843740.7, filed with the China National Intellectual Property Administration on Dec. 28, 2023 and entitled "WIRELINE ACCESS-BASED CONGESTION PROCESSING METHOD AND APPARATUS, READABLE MEDIUM, AND DEVICE", all of which are incorporated herein by reference in their entirety.

### FIELD OF THE TECHNOLOGY

This application relates to the field of computer and communication technologies, and specifically, to a wireline access-based congestion processing method and apparatus, a readable medium, and a device.

### BACKGROUND OF THE DISCLOSURE

In a 5th generation (5G) mobile communication technology and subsequent evolved systems (such as 5G-A and 6G) of the 5th generation mobile communication technology, a high-bandwidth interactive service is an important service type, such as cloud gaming, virtual reality (VR), augmented reality (AR), mixed reality (MR), extended reality (XR), cinematic reality (CR), XR and media services (XRM). These high-bandwidth interactive services have very high requirements on transmission timeliness. In addition, because a data amount is extremely large, if congestion occurs in a transmission process, quality of service (QoS) of these interactive services is severely affected.

In addition, processing devices of the foregoing interactive services are not limited to a radio access technology (RAT) defined by the 3rd generation partnership project (3GPP) organization, and may also support a non-3GPP RAT. In this case, how to perform congestion processing on these interactive services is a technical problem urgently to be resolved.

### SUMMARY

Embodiments of this application provide a wireline access-based congestion processing method and apparatus, a readable medium, and a device, to ensure that a service processing device can implement congestion processing of a service data flow through both a 3GPP RAT and a non-3GPP RAT, which helps to improve utilization and service processing quality of a network bandwidth.

Other features and advantages of this application will become clear through the following detailed descriptions or be partially learned through practice of this application.

According to a first aspect, an embodiment of this application provides a wireline access-based congestion processing method performed by a computer device acting as a residential gateway between a service processing device and a wireline access gateway device, and the congestion processing method including: establishing a protocol data unit (PDU) session with a core network element through the wireline access gateway device; monitoring a service data packet that is transmitted between the service processing device and a service server based on the PDU session; and performing congestion marking processing when the service data packet transmitted between the service processing device and the service server experiences congestion.

According to a second aspect, an embodiment of this application provides a wireline access-based congestion processing method performed by a computer device acting as a wireline access gateway device connected to a residential gateway, the residential gateway being connected to a service processing device, and the congestion processing method including: establishing a PDU session between the residential gateway and a core network element based on a PDU session establishment request transmitted by the residential gateway; monitoring a service data packet that is transmitted between the service processing device and a service server based on the PDU session; and performing congestion marking processing when the service data packet transmitted between the service processing device and the service server experiences congestion.

According to a third aspect, an embodiment of this application provides a non-transitory computer-readable medium, having a computer program stored therein, and when the computer program is executed by a processor, the wireline access-based congestion processing method according to the foregoing embodiments is implemented.

According to a fourth aspect, an embodiment of this application provides a computer device, including: one or more processors; a storage apparatus, configured to store one or more computer programs, and when the one or more computer programs are executed by the one or more processors, the computer device is caused to implement the wireline access-based congestion processing method according to the foregoing embodiments.

In the technical solutions provided in some embodiments of this application, after establishing a PDU session with a core network element through a wireline access gateway device, a residential gateway monitors a service data packet that is transmitted between a service processing device and a service server and that is transmitted based on the PDU session, and performs congestion marking processing when the residential gateway detects that the service data packet transmitted between the service processing device and the service server experiences congestion, so that interworking and integration of a congestion processing mechanism between a 3GPP network and a non-3GPP network can be implemented based on the residential gateway and the wireline access gateway device, thereby ensuring that the service processing device can implement congestion processing of a service data flow through both a 3GPP RAT and a non-3GPP RAT. On the premise that service data flow congestion is reduced, processing flexibility of the service data flow is improved, which helps to improve utilization and service processing quality of a network bandwidth.

The foregoing general descriptions and the following detailed descriptions are merely exemplary and explanatory, and cannot limit this application.

### BRIEF DESCRIPTION OF THE DRAWINGS

FIG. 1 is a schematic diagram of an exemplary system architecture that may be applied to a technical solution in embodiments of this application;

FIG. 2 is a schematic diagram of a transmission process of a multimedia data packet according to an embodiment of this application;

FIG. 3 is a flowchart of a wireline access-based congestion processing method according to an embodiment of this application;

FIG. 4 is a flowchart of a wireline access-based congestion processing method according to an embodiment of this application;

FIG. 5 is a schematic architectural diagram of a service processing device establishing a connection with a 5G core network through a 5G-RG according to an embodiment of this application;

FIG. 6 is a schematic architectural diagram of a service processing device establishing a connection with a 5G core network through an RG according to an embodiment of this application;

FIG. 7 is a schematic diagram of a related control plane protocol stack of a 5G-RG according to an embodiment of this application;

FIG. 8 is a schematic diagram of a related user plane protocol stack of a 5G-RG according to an embodiment of this application;

FIG. 9 is a schematic diagram of a related control plane protocol stack of an FN-RG according to an embodiment of this application;

FIG. 10 is a schematic diagram of a related user plane protocol stack of an FN-RG according to an embodiment of this application;

FIG. 11 is a block diagram of a wireline access-based congestion processing apparatus according to an embodiment of this application;

FIG. 12 is a block diagram of a wireline access-based congestion processing apparatus according to an embodiment of this application; and

FIG. 13 is a schematic structural diagram of a computer system of an electronic device that is suitable for implementing embodiments of this application.

### DESCRIPTION OF EMBODIMENTS

Now, exemplary implementations are described in a more comprehensive manner with reference to accompanying drawings. However, the exemplary implementations can be implemented in various forms, and are not to be understood as being limited to these examples. On the contrary, an objective of providing these implementations is to make this application more comprehensive and complete, and to comprehensively convey a concept of the exemplary implementations to a person in the art.

In addition, features, structures, or characteristics that are described in this application may be combined in one or more embodiments in any appropriate manner. There are many specific details in the following descriptions, so that embodiments of this application can be fully understood. However, a person skilled in the art is to be aware that, when technical solutions in this application are implemented, not all detailed features in the embodiments may be required to be used, one or more specific details may be omitted, or another method, element, apparatus, step, or the like may be used.

In the embodiments of this application, a term "module" or "unit" refers to a computer program having a predetermined function or a part of a computer program, and the "module" or "unit" works with other relevant parts to achieve a predetermined goal, and the predetermined goal may be fully or partially achieved through software, hardware (such as a processing circuit or a memory), or a combination thereof. Similarly, one processor (or a plurality of processors or memories) may be configured to implement one or more modules or units. In addition, each module or each unit may be a part of an integral module or an integral unit that includes a function of the module or the unit.

Block diagrams shown in the accompanying drawings are merely functional entities, and do not necessarily correspond to physically independent entities. In other words, these functional entities may be implemented in a form of software, or be implemented in one or more hardware modules or integrated circuits, or be implemented in different networks and/or processor apparatuses and/or microcontroller apparatuses.

Flowcharts shown in the accompanying drawings are merely exemplary descriptions, and do not necessarily include all content and operations/steps, and are not necessarily performed in a described sequence. For example, some operations/steps may be further decomposed, and some operations/steps may be combined or partially combined. Therefore, an actual sequence for performing these operations/steps may be changed according to an actual situation.

"A plurality of" mentioned in this specification means two or more. "And/or" describes an association relationship between associated objects, and represents that three relationships may exist. For example, A and/or B may represent that: Only A exists, both A and B exist, and only B exists. A character "/" represents an "or" relationship between the associated objects before and after the character.

With the development of 5G and subsequent evolved systems (such as 5G-A and 6G) of 5G, many multimedia services that require a large data volume and a short latency are applied, for example, an interactive service such as a cloud gaming service, VR, AR, MR, XR, or CR.

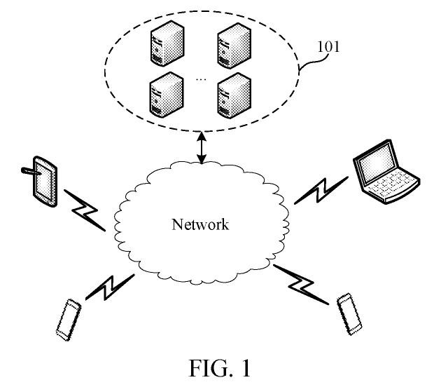

For example, in a cloud gaming scenario shown in FIG. 1, a cloud server 101 is configured to run a cloud game. The cloud server 101 may render a game picture, encode an audio signal and the rendered picture, and finally transmit encoded data that is obtained through encoding to each game client through a network. The game client may be user equipment (UE), such as a smartphone, a tablet computer, a notebook computer, a desktop computer, a smart television, a smart household, a vehicle-mounted terminal, or an aircraft, having a basic streaming media playback capability, a man-machine interaction capability, a communication capability, and the like; or the game client may be an application program running in a terminal device. Specifically, the game client may decode the encoded data transmitted by the cloud server 101, to obtain an analog audio/video signal, and play the analog audio/video signal.

FIG. 1 merely represents an exemplary system architecture of a cloud gaming system, and does not limit a specific architecture of the cloud gaming system. For example, in another embodiment, the cloud gaming system may further include a backend server for scheduling, and the like. In addition, the cloud server 101 may be an independent physical server, or may be a server cluster or a distributed system that is formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The game client and the cloud server 101 may be directly or indirectly connected in a wired or wireless communication manner. This is not limited in this application.

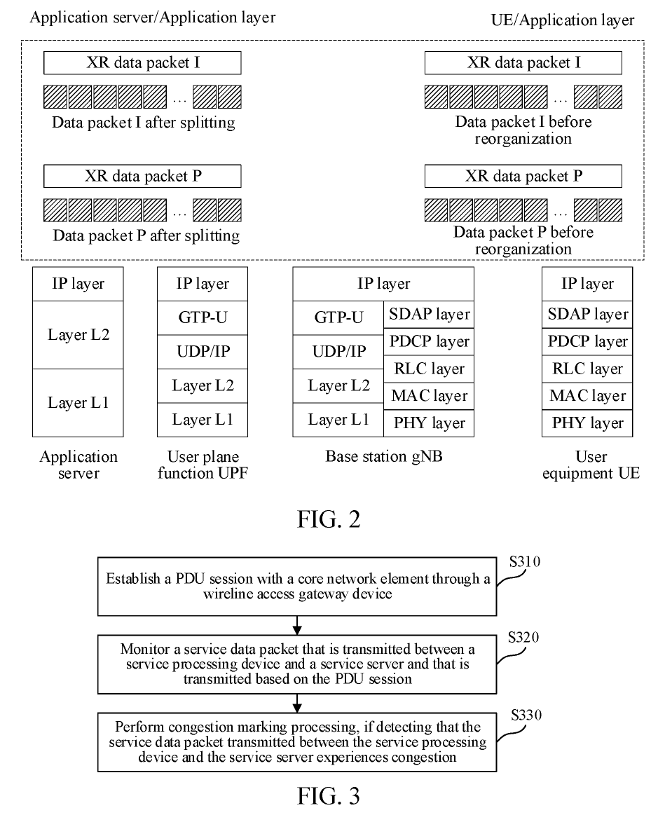

In the foregoing various multimedia-based interactive service application scenarios, because a multimedia data packet is huge, during transmission, the multimedia data packet needs to be split into a plurality of data packets for transmission. Specifically, as shown in FIG. 2, using a 5G system as an example, a user plane includes an application server, a user plane function (UPF), a base station (next generation NodeB, gNB), and UE. For some typical service scenarios, a multimedia data packet is transmitted in a downlink direction. For example, the multimedia data packet is transmitted in a direction from the application server (AS) to the UPF, and then is transmitted to the UE through the gNB. During transmission, the multimedia data packet (an XR data packet is used as an example in FIG. 2) is split at an application layer of the application server. After the split data packet is used as an internet protocol (IP) packet that arrives at the UPF from the application server, the 5G system transmits a data sub-packet to a UE end through a PDU session, and the data sub-packet is transmitted level by level from a protocol stack to upper layers at the UE end, and the data sub-packet is reorganized to restore the multimedia data packet.

In the system shown in FIG. 2, a layer L1 refers to a physical layer, and is configured for ensuring that original data may be transmitted on various physical media. The layer L2 refers to a data link layer, and the data link layer provides a service for a network layer based on a service provided at the physical layer. An IP layer is a network layer, and is configured for implementing data transmission between two end systems. A UDP is a user datagram protocol, and the Chinese name is user datagram protocol. A GTP-U is a general packet radio service (GPRS) tunneling protocol, and the Chinese name is general packet radio service tunneling protocol user plane. PHY is short for physical, and the Chinese name is physical layer. MAC is media access control, and the Chinese name is media access control. RLC is radio link control, and the Chinese name is radio link control layer protocol. A PDCP is a packet data convergence protocol, and the Chinese name is packet data convergence protocol. An SDAP is a service data adaptation protocol, and the Chinese name is service data adaptation protocol.

As described above, for a multimedia service (such as an XRM service), splitting a frame of multimedia data into the plurality of data packets for transmission is very common. A data packet that is formed by a single multimedia service frame or a group of data packets (GoP) may also have a large quantity of bytes, and the large quantity of bytes need to be carried by a series of IP data packets. Specific correlation exists between these IP data packets, and processing these packets according to the correlation can effectively save a wireless network bandwidth.

For example, it is assumed that when data transmission is performed through a plurality of IP packets, the plurality of IP packets may form a PDU set. If some data packets in the PDU set are lost, an entire frame, the GoP, or other video content cannot be decoded, and remaining data in the PDU set is meaningless to a decoder side. However, if an application layer forward error correction (FEC) or another mechanism is introduced, a media application layer has a specific packet loss recovery capability or an anti-packet loss capability. In this way, after some packets are discarded, the remaining data in the PDU set can still be recovered for decoding, which indicates that the remaining data in the PDU set is still meaningful for decoding at a receive end.

In addition, if in a QoS processing mechanism, different PDU sets are distinguished based on correlation between data packets at an application layer, a PDU set that has a high speed but can tolerate a specific proportion of packet loss rate or a latency excess rate may continue to be processed. In other words, a processing manner of the multimedia service may be more flexible. In addition, after congestion occurs in a network, if a multimedia service source can sense the congestion, and adjust a transmission rate in a timely manner, the congestion can be relieved, to reduce lag in the multimedia service, and improve user experience. In addition, after the congestion occurs in the network, if an entity on the network performs packet loss processing based on the PDU set, the congestion can also be reduced. Resolving the congestion problem from two perspectives: a service source and the network is a very necessary means.

During processing of the multimedia service, both a RAT that is organized and defined a 3GPP organization and a non-3GPP RAT can be used. This is because in an actual scenario, using a device that is not defined and organized by a 3GPP organization to process the multimedia service is also common. In this case, how to perform congestion processing on the multimedia service is a technical problem urgently to be resolved.

Based on the foregoing problems, a technical solution in this embodiment of this application provides a new wireline access-based congestion processing solution, and the solution may implement, based on a residential gateway and a wireline access gateway device, interworking and integration of a congestion processing mechanism between a 3GPP network and a non-3GPP network, which further ensures that a service processing device can implement congestion processing on a service data flow through both a 3GPP RAT and a non-3GPP RAT. On the premise that service data flow congestion is reduced, processing flexibility of the service data flow is improved, which helps to improve utilization and service processing quality of a network bandwidth, to better tackle a challenge that is brought by a high-bandwidth interactive service to wireless network transmission.

The following describes implementation details of the technical solutions in this embodiment of this application in detail.

FIG. 3 is a flowchart of a wireline access-based congestion processing method according to an embodiment of this application. The congestion processing method may be performed by a residential gateway. The residential gateway is connected between a service processing device and a wireline access gateway device. In an existing standard, the residential gateway may be a residential gateway (RG). For example, in a 5G technology, the method shown in FIG. 3 may be performed by a 5G-RG. Certainly, a technical solution in the embodiment shown in FIG. 3 may also be performed by another device that can perform a similar function, or may be performed by another network element or device that has a similar function and that is defined in the standard. As shown in FIG. 3, the wireline access-based congestion processing method includes at least S310 to S330, and details are described as follows:

S310: Establish a PDU session with a core network element through a wireline access gateway device.

In some embodiments, descriptions are provided by using an example in which the residential gateway performs the technical solution in the embodiment shown in FIG. 3. The residential gateway may transmit a PDU session establishment request to the wireline access gateway device to initiate a PDU session establishment process, and then the wireline access gateway device may transmit the PDU session establishment request to an access and mobility management function (AMF), and the AMF performs the PDU session establishment process, for example, the AMF performs selection of a session management function (SMF), and initiates a create session management context request, and then establishes the PDU session between the residential gateway and the core network element through interaction between network elements such as the SMF, the AMF, and a policy control function (PCF).

In some embodiments, after PDU session establishment is completed, data may be transmitted between the residential gateway and a service server through a user plane. Specifically, the service server may transmit a downlink data packet that is to be transmitted to the service processing device to the residential gateway through the user plane, and then the residential gateway transmits the downlink data packet to the service processing device connected to the residential gateway. The service processing device may transmit an uplink data packet that is to be transmitted to the service server to residential gateway, and then the residential gateway transmits the uplink data packet to the service server through the user plane.

The service processing device in this embodiment of this application may be a smartphone, a tablet computer, a notebook computer, a desktop computer, a smart television, a smart household, a vehicle-mounted terminal, an aircraft, or the like. The service processing device may be a device that supports a non-3GPP RAT, or may be a device that supports both a 3GPP RAT and the non-3GPP RAT.

In some embodiments, when establishing the PDU session with the core network element, the residential gateway may establish one or more PDU sessions with the core network element through the wireline access gateway device according to a service characteristic corresponding to a to-be-processed service data flow.

The service characteristic corresponding to the service data flow is configured for representing a feature of the service data flow, such as a frame rate, resolution, and a data type included in the service data flow. In some embodiments, the service characteristic may be configured for representing a media type. For example, whether the media type included in the service data flow is an audio, a video, tactile information, or another type may be determined according to the service characteristic corresponding to the service data flow. Certainly, the service characteristic may also be configured for representing a service type of the media. For example, whether a service type corresponding to the service data flow is a cloud gaming service, a remote driving service, a mail transmission service, or another service may be determined according to the service characteristic.

In some embodiments, it is assumed that the service characteristic indicates that the service data flow includes data of a plurality of media types, the residential gateway may establish one PDU session with the core network element through the wireline access gateway device, and the data of different media types corresponds to different QoS flows in the PDU session; or the residential gateway may establish PDU sessions that respectively correspond to different media types with the core network element through the wireline access gateway device.

For example, if the service data flow includes data of an audio type, data of a video type, and data of a tactile information type, the residential gateway may establish one PDU session with the core network element through the wireline access gateway device to carry the data of the three media types, but data of different media types may correspond to different QoS flows in the PDU session. Alternatively, the residential gateway may also establish three PDU sessions with the core network element through the wireline access gateway device. The three PDU sessions respectively correspond to the data of the audio type, the data of the video type, and the data of the tactile information type.

In some embodiments, if the residential gateway needs to establish PDU sessions that respectively correspond to different media types with the core network element through the wireline access gateway device, the residential gateway may establish a plurality of PDU sessions (that is, the PDU sessions respectively corresponding to different media types) by transmitting one PDU session establishment request. Certainly, the residential gateway may also establish the plurality of PDU sessions by transmitting a plurality of PDU session establishment requests, that is, the residential gateway transmits one PDU session establishment request and only one PDU session is established.

In some embodiments, the wireline access gateway device may be a wireline-access gateway function (W-AGF), or may be another network element or device having a similar function.

S320: Monitor a service data packet that is transmitted between the service processing device and the service server and that is transmitted based on the PDU session.

In some embodiments, monitoring the service data packet that is transmitted between the service processing device and the service server and that is transmitted based on the PDU session may be monitoring an uplink service data packet transmitted by the service processing device through an established PDU session, or may be monitoring a downlink service data packet transmitted by the service server through an established PDU session. In other words, the residential gateway can monitor the uplink service data packet transmitted between the service processing device and the service server, can monitor the downlink service data packet transmitted between the service server and the service processing device, and can also simultaneously monitor both the uplink service data packet and the downlink service data packet between the service processing device and the service server.

S330: Perform congestion marking processing if detecting that the service data packet transmitted between the service processing device and the service server experiences congestion.

In some embodiments, a process of performing congestion marking processing by the residential gateway may be performing explicit congestion notification (ECN) marking on the uplink service data packet when the residential gateway detects that the uplink service data packet transmitted by the service processing device to the service server experiences congestion.

In some embodiments, ECN marking performed on the uplink service data packet may be set in an IP header of the uplink service data packet, to indicate that the uplink service data packet experiences network congestion. After the uplink service data packet is transmitted to the service server, the service server learns, according to ECN marking in the uplink service data packet, that the uplink service data packet experiences congestion in a transmission process, and then the service server replies an ACK message with an ECN-echo to the service processing device. When receiving the ACK message with the ECN-echo, the service processing device knows that the uplink service data packet experiences congestion in a network path, and correspondingly adjusts a transmitting rate of the uplink service data packet, to avoid further congestion.

In some embodiments, the process of performing congestion marking processing by the residential gateway may be performing ECN marking on the downlink service data packet when the residential gateway detects that the downlink service data packet transmitted by the service server to the service processing device experiences congestion.

In some embodiments, ECN marking performed on the downlink service data packet may be set in an IP header of the downlink service data packet, to indicate that the downlink service data packet experiences network congestion. After the downlink service data packet is transmitted to the service processing device, the service processing device learns, according to ECN marking in the downlink service data packet, that the downlink service data packet experiences congestion in a transmission process, and then the service processing device replies an ACK message with an ECN-echo to the service server. When receiving the ACK message with the ECN-echo, the service server knows that the downlink service data packet experiences congestion in a network path, and correspondingly adjusts a transmitting rate of the downlink service data packet, to avoid further congestion.

In some embodiments, if the residential gateway detects that a service data packet transmitted between the service processing device and the residential gateway experiences congestion, the residential gateway may also transmit congestion indication information to the wireline access gateway device, so that the wireline access gateway device may transmit the congestion indication information to the core network element. In this way, the core network element may obtain a case in which the service data packet transmitted between the service processing device and the residential gateway experiences congestion, and may take a corresponding measure to reduce the congestion, such as reducing the transmitting rate of the downlink service data packet, or adjusting a QoS parameter of the service data packet.

The congestion indication information is configured for indicating congestion information of the service data packet transmitted between the service processing device and the residential gateway.

In some embodiments, the residential gateway may transmit the congestion indication information to the wireline access gateway device when the residential gateway detects that the uplink service data packet transmitted by the service processing device to the residential gateway experiences congestion; or the residential gateway may transmit the congestion indication information to the wireline access gateway device when the residential gateway detects that the downlink service data packet transmitted by the residential gateway to the service processing device experiences congestion.

In some embodiments, a process of transmitting the congestion indication information to the wireline access gateway device by the residential gateway may be transmitting the congestion indication information to the wireline access gateway device based on a wireline access control plane (W-CP) protocol between the residential gateway and the wireline access gateway device; or may be transmitting the congestion indication information to the wireline access gateway device through a user plane transmission channel between the residential gateway and the wireline access gateway device.

In some embodiments, a process of transmitting, by the residential gateway through the user plane transmission channel between the residential gateway and the wireline access gateway device, the congestion indication information to the wireline access gateway device may be directly transmitting a data packet configured for indicating that the service data packet transmitted between the service processing device and the residential gateway experiences congestion to the wireline access gateway device through the user plane transmission channel between the residential gateway and the wireline access gateway device; or may be adding a flag bit configured for indicating that the service data packet transmitted between the service processing device and the residential gateway experiences congestion to the data packet transmitted to the wireline access gateway device, and then the data packet to which the flag bit is added is transmitted to the wireline access gateway device through the user plane transmission channel between the residential gateway and the wireline access gateway device.

In some embodiments, the residential gateway may perform, through a low latency, low loss, and scalable throughput (L4S) technology, relay processing on the service data packet transmitted between the service processing device and the service server, or the residential gateway may perform, through the L4S technology, congestion marking processing on the service data packet transmitted between the service processing device and the service server.

The low latency refers to duration required for transmitting data from a transmit end to a receive end is as short as possible. The latency refers to a time delay in a transmission process, and may affect a response speed and performance of an application program. A low latency technology can reduce transmission time, and improve the response speed of the application program and user experience. The low loss refers to a case in which a loss rate of a data packet is as low as possible in a network transmission process. A packet loss refers to a case in which some data packets are not successfully transmitted to the receive end in a network transmission process. A low loss technology can ensure integrity and reliability of the data, and avoid errors and losses in the data transmission process. The scalable throughput means that a data processing capability of a network or a system may be expanded according to a requirement. A scalable throughput technology may adjust a processing capability of the network or the system according to an actual requirement, to ensure efficient operation and scalability of the system.

The technical solution in this embodiment of this application enables the residential gateway to implement congestion marking processing based on the L4S technology, which further helps to reduce the latency, reduce the packet loss rate, and implement the scalable throughput. In addition, because congestion marking processing based on the L4S technology provides early congestion feedback, the transmit end can adjust the transmitting rate in a timely manner, thereby improving performance and stability of the network. In addition, in this embodiment of this application, interworking and integration of the L4S technology between the 3GPP network and the non-3GPP network can be implemented, to further ensure that the service processing device can implement L4S based congestion processing through both the 3GPP RAT and the non-3GPP RAT, which helps to improve utilization and service processing quality of a network bandwidth.

In some embodiments, the residential gateway in this embodiment of this application may be the 5G residential gateway, or may be a fixed network (FN)-residential gateway, or may be another network element or device having a similar function, for example, the residential gateway may be another network element or device defined in a subsequent standard. If the residential gateway is the 5G residential gateway (5G-RG), a control plane protocol between the 5G-RG and the wireline access gateway device may be the W-CP protocol, and a user plane protocol may be a wireline access user plane (W-UP) protocol. If the residential gateway is the fixed network-residential gateway (FN-RG), a control plane protocol between the FN-RG and the wireline access gateway device may be a legacy wireline access control plane (L-W-CP) protocol, and a user plane protocol may be a legacy wireline access user plane (L-W-UP) protocol.

In some embodiments, a wireline access protocol between the 5G-RG and the wireline access gateway device may be a wireline access protocol defined by the cablelabs or the broadband forum (BBF), or may be another wireline access protocol that can implement a similar function. A conventional wireline access protocol between the FN-RG and the wireline access gateway device may be a digital subscriber line (DSL) protocol, an Ethernet protocol, a fiber access protocol, or the like.

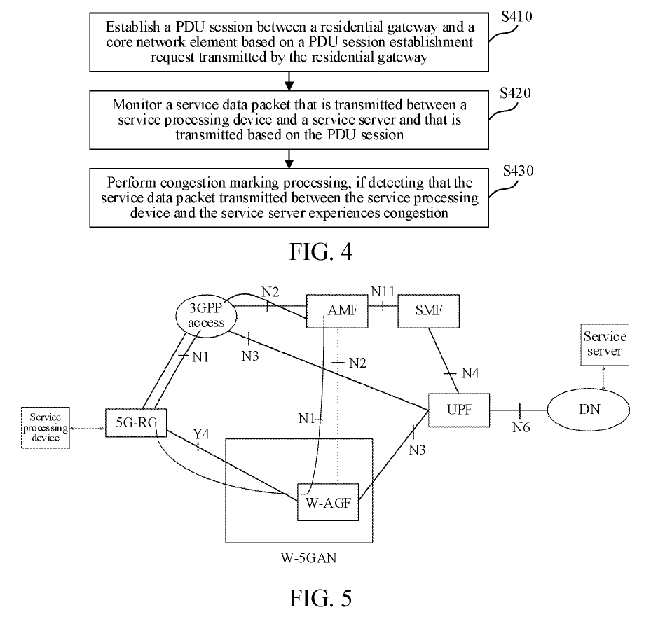

The foregoing describes the technical solution in this embodiment of this application from a perspective of the residential gateway. The following further describes the implementation details of the technical solution in this embodiment of this application from a perspective of the wireline access gateway device with reference to FIG. 4.

FIG. 4 is a flowchart of a wireline access-based congestion processing method according to an embodiment of this application. The congestion processing method may be performed by a wireline access gateway device, the wireline access gateway device is connected to a residential gateway, and the residential gateway is connected to a service processing device. In some embodiments, the wireline access gateway device may be a W-AGF. Certainly, the technical solution in the embodiment shown in FIG. 4 may also be performed by another device that can perform a similar function, or performed by another network element or device that has a similar function and that is defined in a standard. As shown in FIG. 4, the wireline access-based congestion processing method includes at least S410 to S430, and details are described as follows:

S410: Establish a PDU session between the residential gateway and a core network element based on a PDU session establishment request transmitted by the residential gateway.

In some embodiments, for a process in which the wireline access gateway device establishes the PDU session based on the PDU session establishment request transmitted by the residential gateway, refer to the technical solutions in the foregoing embodiments, and details are not described again.

S420: Monitor a service data packet that is transmitted between the service processing device and a service server and that is transmitted based on the PDU session.

In some embodiments, monitoring the service data packet that is transmitted between the service processing device and the service server and that is transmitted based on the PDU session may be monitoring an uplink service data packet transmitted by the service processing device through an established PDU session, or may be monitoring a downlink service data packet transmitted by the service server through an established PDU session. In other words, the wireline access gateway device can monitor the uplink service data packet transmitted between the service processing device and the service server, can monitor the downlink service data packet transmitted between the service server and the service processing device, and can also simultaneously monitor both the uplink service data packet and the downlink service data packet between the service processing device and the service server.

S430: Perform congestion marking processing if detecting that the service data packet transmitted between the service processing device and the service server experiences congestion.

In some embodiments, a process of performing congestion marking processing by the wireline access gateway device may be performing ECN marking on the uplink service data packet when the wireline access gateway device detects that the uplink service data packet transmitted by the service processing device to the service server experiences congestion.

In some embodiments, ECN marking performed on the uplink service data packet may be set in an IP header of the uplink service data packet, to indicate that the uplink service data packet experiences network congestion. After the uplink service data packet is transmitted to the service server, the service server learns, according to ECN marking in the uplink service data packet, that the uplink service data packet experiences congestion in a transmission process, and then the service server replies an ACK message with an ECN-echo to the service processing device. When receiving the ACK message with the ECN-echo, the service processing device knows that the uplink service data packet experiences congestion in a network path, and correspondingly adjusts a transmitting rate of the uplink service data packet, to avoid further congestion.

In some embodiments, a process of performing congestion marking processing by the wireline access gateway device may be performing ECN marking on the downlink service data packet when the wireline access gateway device detects that the downlink service data packet transmitted by the service server to the service processing device experiences congestion.

In some embodiments, ECN marking performed on the downlink service data packet may be set in an IP header of the downlink service data packet, to indicate that the downlink service data packet experiences network congestion. After the downlink service data packet is transmitted to the service processing device, the service processing device learns, according to ECN marking in the downlink service data packet, that the downlink service data packet experiences congestion in a transmission process, and then the service processing device replies an ACK message with an ECN-echo to the service server. When receiving the ACK message with the ECN-echo, the service server knows that the downlink service data packet experiences congestion in a network path, and correspondingly adjusts a transmitting rate of the downlink service data packet, to avoid further congestion.

In some embodiments, the wireline access gateway device may further obtain congestion information of the service data packet transmitted between the service processing device and the service server, and then transmit the congestion information to the core network element. In this way, the core network element may determine, according to the congestion information transmitted by the wireline access gateway device, whether to take a corresponding measure to reduce congestion, such as reducing the transmitting rate of the downlink service data packet, and adjusting a quality of service (QoS) parameter of the service data packet.

In some embodiments, a manner of obtaining, by the wireline access gateway device, the congestion information of the service data packet transmitted between the service processing device and the service server may include at least one of the following manners: detecting congestion information of a service data packet that is relayed by the wireline access gateway device; generating congestion information according to a wireline access parameter; and receiving congestion indication information reported by the residential gateway, where the congestion indication information is configured for indicating the congestion information of the service data packet transmitted between the service processing device and the residential gateway.

In some embodiments, the service data packet relayed by the wireline access gateway device may be the uplink service data packet transmitted by the service processing device to the service server, or may be the downlink service data packet transmitted by the service server to the service processing device.

In some embodiments, a traffic control queue profile (TC-Queue-Profile) defined by a descriptor field of the service data packet relayed by the wireline access gateway device may be detected, to detect the congestion information of the service data packet relayed by the wireline access gateway device. The TC-Queue-Profile is a parameter set configured for defining and controlling network traffic. The parameter set may include a priority of a queue, bandwidth allocation of the queue, a latency of the queue, and the like. The queue refers to a queue to which the service data packet relayed by the wireline access gateway device belongs. When the network traffic increases and congestion may be caused, the TC-Queue-Profile may provide useful information.

In some embodiments, the traffic control queue profile defined by the descriptor field of the service data packet relayed by the wireline access gateway device is detected, to detect the congestion information of the service data packet relayed by the wireline access gateway device includes at least one of the following:

determining that congestion exists in a network path corresponding to the queue to which the service data packet belongs if bandwidth utilization of the queue to which the service data packet belongs is greater than bandwidth utilization of another queue within preset duration; and

determining that congestion exists in the network path corresponding to the queue to which the service data packet belongs if a latency of the queue to which the service data packet belongs is greater than a preset latency.

For example, if the bandwidth utilization of the queue to which the service data packet relayed by the wireline access gateway device belongs is continuously greater than the bandwidth utilization of the another queue, it may indicate that congestion exists in the network path corresponding to the queue.

For example, if latency time of the queue to which the service data packet relayed by the wireline access gateway device belongs is increased, it may also indicate that congestion exists in the network path corresponding to the queue.

For example, if a packet loss phenomenon occurs in the queue to which the service data packet relayed by the wireline access gateway device belongs, it may also indicate that congestion exists in the network path corresponding to the queue.

Therefore, the TC-Queue-Profile defined by the descriptor field of the service data packet relayed by the wireline access gateway device may be extracted, to determine the congestion information of the service data packet.

In some embodiments, generating congestion information according to a wireline access parameter may be generating the congestion information according to a residential gateway level wireline access characteristic (RG-LWAC) of the wireline access gateway device. The RG-LWAC of the wireline access gateway device is configured for describing a wired link of the wireline access gateway device, for example, a transmission rate, a jitter characteristic, and a packet loss rate that can be supported. Therefore, congestion information of the corresponding wired link may be generated according to the RG-LWAC.

In some embodiments, that the congestion information is generated according to the residential gateway level wireline access characteristic of the wireline access gateway device includes at least one of the following:

generating the congestion information if the transmission rate of the wired link is less than a preset rate;

generating the congestion information if jitter of the wired link is greater than preset duration; and

generating the congestion information if the packet loss rate of the wired link is greater than a preset packet loss rate.

For example, if the transmission rate of the wired link of the wireline access gateway device is low, it indicates that a quantity of data packets that are waiting to be transmitted is large. In this case, congestion may occur in a network. Therefore, the congestion information of the wired link may be generated according to the transmission rate of the wired link of the wireline access gateway device.

For example, if the jitter of the wired link of the wireline access gateway device is large, it indicates that the quantity of data packets that are waiting to be transmitted is large. In this case, congestion may occur in the network. Therefore, the congestion information of the wired link may be generated according to the jitter characteristic of the wired link of the wireline access gateway device.

For example, if the packet loss rate of the wired link of the wireline access gateway device is large, it indicates that the quantity of data packets that are waiting to be transmitted is large. In this case, congestion may occur in the network. Therefore, the congestion information of the wired link may be generated according to the packet loss rate of the wired link of the wireline access gateway device.

In some embodiments, generating the congestion information according to the wireline access parameter may be generating the congestion information according to a quantity of buffers.

In some embodiments, the generating the congestion information according to a quantity of buffers includes: generating the congestion information if the quantity of buffers is greater than a preset quantity.

For example, if the quantity of the buffers is large, it indicates that the quantity of data packets that are waiting to be transmitted is large. In this case, congestion may occur in the network. Therefore, the congestion information of the wired link may be generated according to the quantity of buffers.

In some embodiments, the generating the congestion information according to a quantity of buffers includes: generating the congestion information if the quantity of buffers is greater than a product of the preset quantity and a first preset factor. The first preset factor may be greater than 0 and less than 1.

In some embodiments, generating the congestion information according to the wireline access parameter may be generating the congestion information according to a length of a data packet queue.

In some embodiments, the generating the congestion information according to a length of the queue to which the service data packet belongs includes: generating the congestion information if the length of the queue to which the service data packet belongs is greater than a preset length.

For example, if the length of the data packet queue is large, it indicates that the quantity of data packets that are waiting to be transmitted is large. In this case, congestion may occur in the network. Therefore, the congestion information of the wired link may be generated according to the length of the data packet queue.

In some embodiments, the generating the congestion information according to a length of the queue to which the service data packet belongs includes: generating the congestion information if the length of the queue to which the service data packet belongs is greater than a product of the preset length and a second preset factor. The second preset factor may be greater than 0 and less than 1.

In some embodiments, the congestion indication information reported by the residential gateway may be congestion information of the uplink service data packet between the service processing device and the residential gateway; or may be congestion information of the downlink service data packet between the residential gateway and the service processing device; or may also include congestion information of the uplink service data packet between the service processing device and the residential gateway, and congestion information of the downlink service data packet between the residential gateway and the service processing device.

In some embodiments, the wireline access gateway device may perform, through an L4S technology, relay processing on the service data packet transmitted between the service processing device and the service server. The technical solution in this embodiment of this application enables the wireline access gateway device to implement congestion marking processing based on the L4S technology, which further helps to reduce the latency, reduce the packet loss rate, and implement a scalable throughput. In addition, because congestion marking processing based on the L4S technology provides early congestion feedback, a transmit end can adjust the transmitting rate in a timely manner, thereby improving performance and stability of the network. In addition, in this embodiment of this application, interworking and integration of the L4S technology between a 3GPP network and a non-3GPP network can be implemented, to further ensure that the service processing device can implement L4S-based congestion processing through both a 3GPP RAT and a non-3GPP RAT, which helps to improve utilization and service processing quality of a network bandwidth.

In some embodiments, the wireline access gateway device may obtain QoS profile information configured for performing the L4S technology on the service data packet, and then perform, according to the QoS profile information, QoS processing in a process of transmitting the service data packet between the service processing device and the service server.

In some embodiments, the QoS profile information that is configured for performing the L4S technology on the service data packet and that is obtained by the wireline access gateway device may be configured for indicating congestion processing based on the L4S technology. For example, if the wireline access gateway device detects that the downlink service data packet from the service server experiences congestion, discard processing may be performed on the downlink service data packet. In some embodiments, when discard processing is performed on the downlink service data packet, the downlink service data packet may be discarded in ascending order of a priority of the downlink service data packet; or a downlink service data packet that cannot satisfy a delay requirement may also be discarded.

For another example, if the wireline access gateway device detects that the uplink service data packet from the service processing device experiences congestion, discard processing may be performed on the uplink service data packet. In some embodiments, when discard processing is performed on the uplink service data packet, the uplink service data packet may be discarded in ascending order of a priority of the uplink service data packet; or an uplink service data packet that cannot satisfy a delay requirement may be discarded.

The QoS profile information may also include other QoS parameter information, such as a delay requirement and a bit error rate requirement. In this case, the wireline access gateway device may perform, according to the QoS profile information, QoS processing in a process of transmitting a service data flow between the service processing device and the service server.

In some embodiments, if the wireline access gateway device detects that transmission delay information of the downlink data packet from the service server cannot satisfy the delay requirement included in the QoS profile information, the downlink data packet may be discarded. For a downlink data packet transmitted in a PDU set manner, the delay requirement included in the QoS profile information is a PDU set delay budget (PSDB). For a downlink data packet transmitted in a per-packet manner, the delay requirement included in the QoS profile information is a packet delay budget (PDB).

In some embodiments, if the wireline access gateway device detects that a bit error rate of the downlink data packet from the service server cannot satisfy the bit error rate requirement included in the QoS profile information, the downlink data packet may be discarded. For the downlink data packet transmitted in the PDU set manner, a bit error rate included in the QoS profile information is a PDU set error rate (PSER). For the downlink data packet transmitted in the per-packet manner, the bit error rate included in the QoS profile information is a packet error rate (PER).

In some embodiments, if the wireline access gateway device detects that transmission delay information of the uplink data packet from the service processing device cannot satisfy the delay requirement included in the QoS profile information, the uplink data packet may be discarded. For an uplink data packet transmitted in the PDU set manner, the delay requirement included in the QoS profile information is the PSDB. For an uplink data packet transmitted in the per-packet manner, the delay requirement included in the QoS profile information is the PDB.

In some embodiments, if the wireline access gateway device detects that a bit error rate of the uplink data packet from the service processing device cannot satisfy the bit error rate requirement included in the QoS profile information, the uplink data packet may be discarded. For the uplink data packet transmitted in the PDU set manner, the bit error rate included in the QoS profile information is the PSER. For the uplink data packet transmitted in the per-packet manner, the bit error rate included in the QoS profile information is the PER.

With reference to a 5G network, the following describes implementation details of a technical solution in this embodiment of this application in detail by using an example in which a wireline access gateway device is a W-AGF.

FIG. 5 is a schematic architectural diagram of a service processing device establishing a connection with a 5G core network through a 5G-RG. In a system architecture shown in FIG. 5, the 5G-RG is an RG that can be connected to the 5G core network (5GC) network, and may exchange N1 signaling with the bGC. The 5G-RG may be a 5G-BRG or a 5G-CRG, where the 5G-BRG is a 5G-RG defined in the BBF, and the 5G-CRG is a 5G-RG defined in the CableLabs.

A wireline 5G access network (W-5GAN) is a wireline access network (AN) connected to the 5GC through an N2 reference point and an N3 reference point. The W-5GAN may be a W-5GBAN (that is, a W-5GAN defined in the BBF) or a W-5GCAN (that is, a W-5GAN defined in the CableLabs).

In the system architecture shown in FIG. 5, the 5G-RG may access the 5G core network through the W-AGF; or if the 5G-RG has a capability of a 3GPP RAT, the 5G-RG may also access the 5G core network through 3GPP access. The service processing device is connected to the 5G-RG, and a service server is located at a backend of the 5G core network, and is connected to a data network (DN).

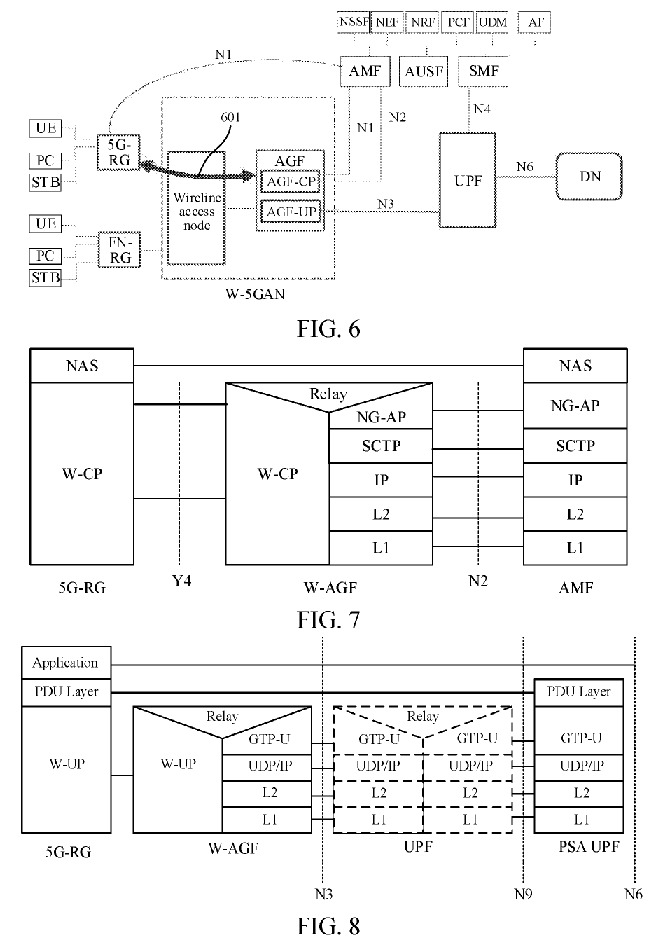

For other core network elements that are not shown in FIG. 5, refer to FIG. 6, which may include an authentication server function (AUSF), a network slice selection function (NSSF), a network exposure function (NEF), a network repository function (NRF), unified data management (UDM), an application function (AF), and the like.

The service processing device may be a device (an XRM Device) for processing an XRM service. For example, the service processing device may be UE, a personal computer (PC), or a digital video set top box (STB). The service server may be a server (an XRM Server) for processing the XRM service, and the service processing device may be connected to the 5G-RG in a wired or wireless manner. An AGF-CP shown in FIG. 6 is a control plane of an access gateway function, and an AGF-UP is a user plane of the access gateway function.

In some embodiments, the following new functions may be introduced to the 5G-RG shown in FIGS. 5 and 6, but are not limited to: a function of ECN marking for L4S that supports the XRM device; and a function of monitoring congestion from the XRM device to the 5G-RG on the 5G-RG, and reporting congestion to the W-AGF if congestion occurs.

In some embodiments, the function of ECN marking for L4S that is supported by the 5G-RG may be performing ECN marking on an uplink service data packet transmitted by the XRM device, or may be performing ECN marking on a downlink service data packet transmitted by the XRM server.

In some embodiments, when the 5G-RG reports congestion to the W-AGF, congestion may be reported through 601 shown in FIG. 6. Specifically, different manners may be used, which include, but are not limited to: a manner implemented based on a W-CP protocol defined in the BBF or the Cablelabs; and a user plane manner that is used to perform transfer between the 5G-RG and an AGF through an IP packet or another data packet, or to directly mark a congestion position in an IP packet, so that when the 5G-RG forwards a data packet to the AGF, congestion is directly indicated through the marked congestion position, and when the AGF forwards the data packet to the 5GC, congestion may also be directly indicated through the marked congestion position.

In some embodiments, the following new functions may be introduced to the W-AGF, but are not limited to: a congestion measurement and marking function that supports an N2/N3 end point, that is, ECN marking for L4S; a function of representing non-3GPP wireline access to perform congestion measurement between UPF interfaces, where both congestion measured by the W-AGF and congestion reported by the 5G-RG are reflected as congestion in a transmission path for the 5GC; and a function of forming congestion information based on a parameter of the non-3GPP wireline access, such as an RG-LWAC, a quantity of buffers, a queue length, or other information, and transmitting the congestion information to the 5GC.

In some embodiments, the ECN marking for L4S function supported by the W-AGF may be performing ECN marking on the uplink service data packet transmitted by the XRM device, or may be performing ECN marking on the downlink service data packet transmitted by the XRM server.

In some embodiments, the process in which the W-AGF transmits the congestion information (the congestion information may be obtained by measurement or the congestion information is formed according to the parameter of the non-3GPP wireline access) to the 5GC and the process of performing ECN marking for L4S may be two processes independent of each other, or may be associated with each other.

Specifically, as shown in FIG. 7, in a related control plane protocol stack of a 5G-RG, the bG-RG that supports L4S processing may implement a UE side function, that is, a non-access stratum (NA) protocol N1 interface is terminated. In addition, a W-AGF may implement a wireless access side function, that is, an N2 interface is terminated. A W-CP protocol between the 5G-RG and the W-AGF may be a wireline access protocol defined in the CableLabs or the BBF, or may be another wireline access protocol that can implement a similar function. The W-CP protocol needs to satisfy a security assurance mechanism that carries the NAS protocol, which is like functions provided by a packet data convergence protocol (PDCP)/radio link control (RLC) protocol. In other words, the W-CP protocol needs to provide ciphering and integrity protection functions.

In some embodiments, the 5G-RG may also obtain, from an SMF via an AMF, QoS rule information (QoS rules) that is configured for an L4S function and that is configured by a core network, to perform QoS processing on a service data flow between a service processing device and a service server. Specifically, after generating the QoS rule information configured for the L4S function, the SMF may transmit the QoS rule information to the AMF through an N11 interface, and then the AMF forwards the QoS rule information to the 5G-RG through the W-AGF. Alternatively, after generating the QoS rule information configured for the L4S function, the SMF may transmit the QoS rule information to a UPF through an N4 interface, and then the UPF forwards the QoS rule information to the 5G-RG through the W-AGF. Alternatively, if the 5G-RG can access a 5GC through 3GPP access, after the SMF generates the QoS rule information configured for the L4S function, the SMF may transmit the QoS rule information to the AMF through the N11 interface, and then the AMF forwards the QoS rule information to the 5G-RG through a RAN.

In some embodiments, after generating QoS profile information (QoS profile) configured for the L4S function, the SMF may transmit the QoS profile information to the AMF through the N11 interface, and then the AMF transmits the QoS profile information to the W-AGF, to perform QoS processing on the service data flow between the service processing device and the service server.

In a control plane protocol stack shown in FIG. 7, a protocol stack between the W-AGF and the AMF includes an NG application protocol (NG-AP), a stream control transmission protocol (SCTP), an internet protocol (IP), a layer L2 protocol (which includes a data link layer protocol), and a layer L1 protocol (which includes a physical layer protocol).

Referring to FIG. 8, in a related user plane protocol stack of a 5G-RG, a W-UP protocol is terminated at the 5G-RG, and the 5G-RG implements a UE user plane function in L4S processing.

In the user plane protocol stack shown in FIG. 8, a protocol stack between a W-AGF and a UPF, and a protocol stack between the UPF and a PDU session anchor (PSA) UPF include a GPRS tunnel protocol user plane (GTP-U), a user datagram protocol (UDP)/ an IP, a layer L2 protocol, and a layer L1 protocol.

In some embodiments, a method for extracting congestion information by the W-AGF is related to implementation of a W-CP protocol and implementation of a W-UP protocol. For example, the congestion information may be obtained by extracting a TC-Queue-Profile defined in a descriptor of an uplink service data packet or a descriptor of a downlink service data packet, or the congestion information may be obtained in another manner. Specifically, because the TC-Queue-Profile is a parameter set configured for defining and controlling network traffic, the parameter set may include a priority of a queue, bandwidth allocation of the queue, a latency of the queue, and the like. Therefore, if bandwidth utilization of a queue is continuously greater than bandwidth utilization of another queue, it may indicate that congestion exists in a network path corresponding to the queue; and if latency time of a queue is increased or a packet loss phenomenon occurs in a queue, it may also indicate that congestion exists in the network path corresponding to the queue.

In an embodiment of this application, in addition to the 5G-RG, an FN-RG may also have a similar function. Specifically, as shown in FIG. 6, the FN-RG may access a 5G core network through a W-5GAN, and a service processing device connected to the FN-RG may be UE, a PC, an STB, or the like.

In some embodiments, the following new functions may be introduced to the FN-RG, but are not limited to: a function that supports ECN marking for L4S; and a function of monitoring congestion from the XRM device to the FN-RG on the FN-RG, and reporting congestion to the W-AGF if congestion occurs.

In some embodiments, the ECN marking for L4S function supported by the FN-RG may be performing ECN marking on the uplink service data packet transmitted by the XRM device, or may be performing ECN marking on the downlink service data packet transmitted by the XRM server.

In some embodiments, when the FN-RG reports congestion to the W-AGF, congestion may be reported in different manners, which include, but are not limited to: a manner implemented based on an L-W-CP protocol defined in a conventional wireline access protocol; a user plane manner that is used to perform transfer between the FN-RG and the AGF through an IP packet or another data packet, or directly mark a congestion position in an IP packet, so that when the FN-RG forwards a data packet to the AGF, congestion is directly indicated through the marked congestion position, and when the AGF forwards the data packet to the 5GC, congestion may also be directly indicated through the marked congestion position.

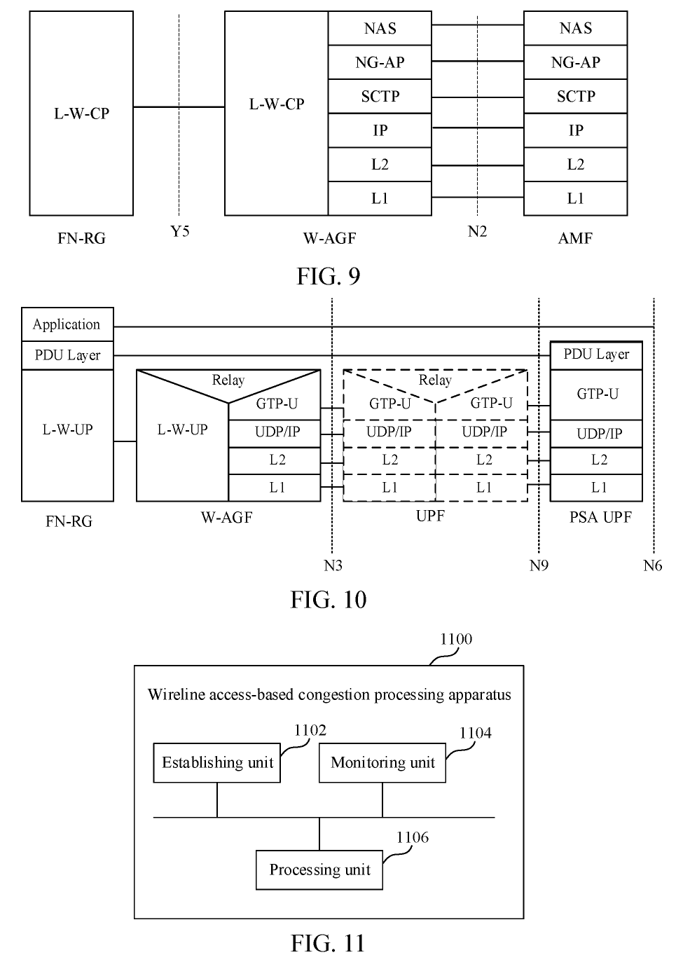

Referring to FIG. 9, in a related control plane protocol stack of an FN-RG, an L-W-CP protocol between the FN-RG and a W-AGF may be a DSL protocol, an Ethernet protocol, an optical access protocol, or the like. In the control plane protocol stack shown in FIG. 9, a protocol stack between the W-AGF and an AMF includes an NAS protocol, an NG-AP protocol, an SCTP protocol, an IP protocol, a layer L2 protocol, and a layer L1 protocol.

Referring to FIG. 10, in a related user plane protocol stack of an FN-RG, an L-W-UP protocol is terminated at the FN-RG, and the FN-RG implements a UE user plane function in L4S processing.

In the user plane protocol stack shown in FIG. 10, a protocol stack between a W-AGF and a UPF and a protocol stack between a UPF and a PSA UPF include a GTP-U, a UDP/IP, a layer L2 protocol, and a layer L1 protocol.

In conclusion, in the technical solutions in this embodiment of this application, a strategy for monitoring and reporting network congestion may be exchanged with a non-3GPP CP protocol and a non-3GPP UP protocol, to implement support for the L4S function in the non-3GPP access network. Further, the L4S mechanism can be extended to a wired broadband scenario, so that the L4S mechanism implements interworking and integration between the 3GPP network and the non-3GPP network, which helps to support the multi-RAT (that is, the 3GPP RAT and the non-3GPP RAT) service processing device in performing switching according to a network environment and another factor (such as a fee factor). In this way, processing flexibility of the service data flow is improved, and an immersive multimedia service (such as the XRM service) is ensured to be better popularized.

In the foregoing embodiments, the service data packet may be transmitted between the service processing device and the service server in the PDU set manner, or the service data packet may be transmitted in the per-packet manner. In the foregoing embodiments, an example in which the wireline access gateway device is the W-AGF is used for description. In another embodiment of this application, the wireline access gateway device may also be another network element or device that implements a similar function. In addition, the technical solutions in this embodiment of this application are not only applicable to a 5G standard, but also applicable to another standard.

The following describes an apparatus embodiment in this application, and the apparatus embodiment may be used for performing the wireline access-based congestion processing method in the foregoing embodiments of this application. For details not disclosed in the apparatus embodiment of this application, refer to the wireline access-based congestion processing method embodiment of this application.

FIG. 11 is a block diagram of a wireline access-based congestion processing apparatus according to an embodiment of this application. The congestion processing apparatus may be applied to a residential gateway. The residential gateway is connected between a service processing device and a wireline access gateway device. For example, in a 5G technology, the congestion processing apparatus shown in FIG. 11 may be applied to a 5G-RG. Certainly, the congestion processing apparatus shown in FIG. 11 may also be applied to another device that can perform a similar function.

Referring to FIG. 11, a wireline access-based congestion processing apparatus 1100 according to an embodiment of this application includes an establishing unit 1102, a monitoring unit 1104, and a processing unit 1106.

The establishing unit 1102 is configured to establish a PDU session with a core network element through the wireline access gateway device. The monitoring unit 1104 is configured to monitor a service data packet that is transmitted between the service processing device and a service server and that is transmitted based on the PDU session. The processing unit 1106 is configured to perform congestion marking processing if detecting that the service data packet transmitted between the service processing device and the service server experiences congestion.

In some embodiments of this application, based on the foregoing solutions, the processing unit 1106 is configured to perform at least one of the following manners: if it is detected that an uplink service data packet that is transmitted by the service processing device to the service server experiences congestion, performing explicit congestion notification ECN marking on the uplink service data packet; and if it is detected that a downlink service data packet that is transmitted by the service server to the service processing device experiences congestion, performing ECN marking on the downlink service data packet.

In some embodiments of this application, based on the foregoing solutions, the processing unit 1106 is further configured to: transmit congestion indication information to the wireline access gateway device if detecting that a service data packet transmitted between the service processing device and the residential gateway experiences congestion, where the congestion indication information is configured for indicating congestion information of the service data packet transmitted between the service processing device and the residential gateway.

In some embodiments of this application, based on the foregoing solutions, a process in which the processing unit 1106 transmits the congestion indication information to the wireline access gateway device includes: transmitting the congestion indication information to the wireline access gateway device based on a wireline access control plane protocol between the residential gateway and the wireline access gateway device; or

transmitting the congestion indication information to the wireline access gateway device through a user plane transmission channel between the residential gateway and the wireline access gateway device.

In some embodiments of this application, based on the foregoing solutions, that the processing unit 1106 transmits the congestion indication information to the wireline access gateway device through the user plane transmission channel between the residential gateway and the wireline access gateway device includes: transmitting a data packet configured for indicating that the service data packet transmitted between the service processing device and the residential gateway experiences congestion to the wireline access gateway device through the user plane transmission channel between the residential gateway and the wireline access gateway device; or

adding a flag bit configured for indicating that the service data packet transmitted between the service processing device and the residential gateway experiences congestion to the data packet that is transmitted to the wireline access gateway device, and transmitting, through the user plane transmission channel between the residential gateway and the wireline access gateway device, the data packet to which the flag bit is added to the wireline access gateway device.

In some embodiments of this application, based on the foregoing solutions, that the processing unit 1106 performs congestion marking processing if detecting that the service data packet transmitted between the service processing device and the service server experiences congestion includes: performing, by the processing unit 1106 through an L4S technology, congestion marking processing on the service data packet transmitted between the service processing device and the service server if detecting that the service data packet transmitted between the service processing device and the service server experiences congestion.

In some embodiments of this application, based on the foregoing solutions, the residential gateway includes at least one of a 5G residential gateway and a fixed network-residential gateway.

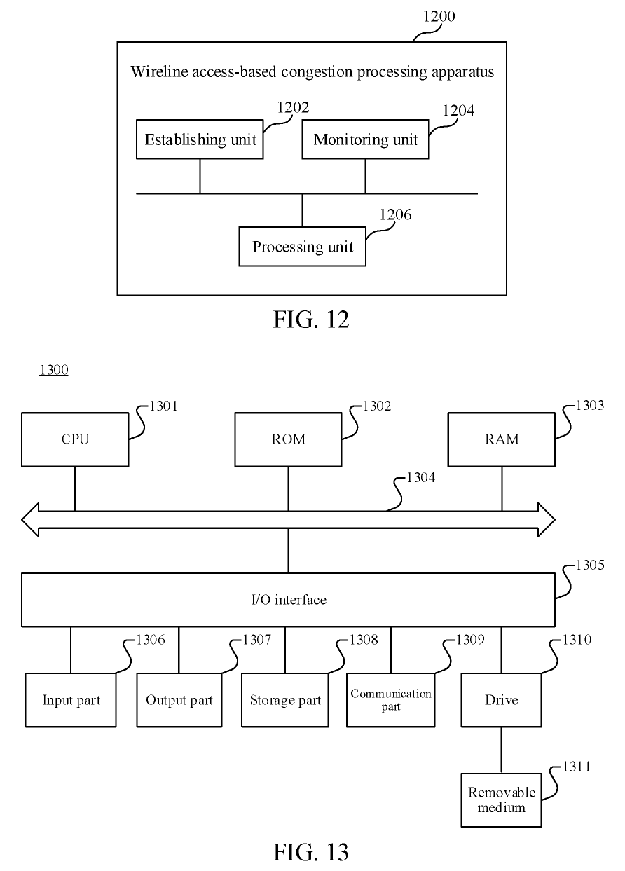

FIG. 12 is a block diagram of a wireline access-based congestion processing apparatus according to an embodiment of this application. The congestion processing apparatus may be applied to a wireline access gateway device. The wireline access gateway device is connected to a residential gateway, and the residential gateway is connected to a service processing device. Certainly, the congestion processing apparatus shown in FIG. 12 may also be applied to another device that can perform a similar function.

Referring to FIG. 12, a wireline access-based congestion processing apparatus 1200 according to an embodiment of this application includes an establishing unit 1202, a monitoring unit 1204, and a processing unit 1206.

The establishing unit 1202 is configured to establish a PDU session between the residential gateway and a core network element based on a PDU session establishment request transmitted by the residential gateway. The monitoring unit 1204 is configured to monitor a service data packet that is transmitted between the service processing device and a service server and that is transmitted based on the PDU session. The processing unit 1206 is configured to perform congestion marking processing if detecting that the service data packet transmitted between the service processing device and the service server experiences congestion.

In some embodiments of this application, based on the foregoing solutions, the processing unit 1206 is configured to perform at least one of the following manners: performing ECN marking on an uplink service data packet if detecting that the uplink service data packet that is transmitted by the service processing device to the service server experiences congestion; and performing ECN marking on a downlink service data packet if detecting that the downlink service data packet that is transmitted by the service server to the service processing device experiences congestion.

In some embodiments of this application, based on the foregoing solutions, the processing unit 1206 is further configured to: obtain congestion information of the service data packet transmitted between the service processing device and the service server, and transmit the congestion information to the core network element.

In some embodiments of this application, based on the foregoing solutions, the processing unit 1206 obtains the congestion information of the service data packet transmitted between the service processing device and the service server in at least one of the following manners:

detecting congestion information of a service data packet relayed by the wireline access gateway device;

generating the congestion information according to a wireline access parameter; and

receiving congestion indication information reported by the residential gateway, where the congestion indication information is configured for indicating congestion information of a service data packet transmitted between the service processing device and the residential gateway.

In some embodiments of this application, based on the foregoing solutions, the processing unit 1206 detects the congestion information of the service data packet relayed by the wireline access gateway device includes: detecting a traffic control queue profile defined by a descriptor field of the service data packet relayed by the wireline access gateway device, to detect the congestion information of the service data packet relayed by the wireline access gateway device.

In some embodiments of this application, based on the foregoing solutions, the traffic control queue profile is configured for defining and controlling a parameter set of network traffic, and the parameter set includes at least one of bandwidth utilization and a latency of a queue to which the service data packet belongs.

That the processing unit 1206 detects the traffic control queue profile defined by the descriptor field of the service data packet relayed by the wireline access gateway device, to detect the congestion information of the service data packet relayed by the wireline access gateway device includes at least one of the following:

determining, by the processing unit 1206, that congestion exists in a network path corresponding to the queue to which the service data packet belongs if the bandwidth utilization of the queue to which the service data packet belongs is greater than bandwidth utilization of another queue within preset duration; and

determining, by the processing unit 1206, that congestion exists in the network path corresponding to the queue to which the service data packet belongs if the latency of the queue to which the service data packet belongs is greater than a preset latency.

In some embodiments of this application, based on the foregoing solutions, the processing unit 1206 generates the congestion information according to the wireline access parameter includes: generating, by the processing unit 1206, the congestion information according to a residential gateway level wireline access characteristic of the wireline access gateway device.

In some embodiments of this application, based on the foregoing solutions, the residential gateway level wireline access characteristic is configured for describing a wired link of the wireline access gateway device, and includes at least one of the following: a transmission rate, a jitter characteristic, and a packet loss rate that are supported by the wired link.

The generating, by the processing unit 1206, the congestion information according to a residential gateway level wireline access characteristic of the wireline access gateway device includes at least one of the following:

generating, by the processing unit 1206, the congestion information if the transmission rate of the wired link is less than a preset rate;

generating, by the processing unit 1206, the congestion information if jitter of the wired link is greater than preset duration; and

generating, by the processing unit 1206, the congestion information if the packet loss rate of the wired link is greater than a preset packet loss rate.

In some embodiments of this application, based on the foregoing solutions, that the processing unit 1206 generates the congestion information according to the wireline access parameter includes: generating, by the processing unit 1206, the congestion information according to a quantity of buffers.

In some embodiments of this application, based on the foregoing solutions, the generating, by the processing unit 1206, the congestion information according to a quantity of buffers includes: generating, by the processing unit 1206, the congestion information if the quantity of the buffers is greater than a preset quantity.

In some embodiments of this application, based on the foregoing solutions, that the processing unit 1206 generates the congestion information according to the wireline access parameter includes: generating, by the processing unit 1206, the congestion information according to a length of the queue to which the service data packet belongs.

In some embodiments of this application, based on the foregoing solutions, the generating, by the processing unit 1206, the congestion information according to a length of the queue to which the service data packet belongs includes: generating, by the processing unit 1206, the congestion information if the length of the queue to which the service data packet belongs is greater than a preset length.

In some embodiments of this application, based on the foregoing solutions, that the processing unit 1206 performs congestion marking processing if detecting that the service data packet transmitted between the service processing device and the service server experiences congestion includes: performing, by the processing unit 1206 through an L4S technology, congestion marking processing on the service data packet transmitted between the service processing device and the service server if detecting that the service data packet transmitted between the service processing device and the service server experiences congestion.

In some embodiments of this application, based on the foregoing solutions, the processing unit 1206 is further configured to: obtain QoS profile information configured for performing the L4S technology on the service data packet; and performing QoS processing in a process of transmitting the service data packet between the service processing device and the service server according to the QoS profile information.

FIG. 13 is a schematic structural diagram of a computer system of an electronic device that is suitable for implementing embodiments of this application. The electronic device may be a residential gateway or a wireline access gateway device in the foregoing embodiments.

The computer system 1300 of the electronic device shown in FIG. 13 is merely an example, and is not to bring any limitation to a function and a use scope of the embodiments of this application.

As shown in FIG. 13, the computer system 1300 may include a central processing unit (CPU) 1301, which may perform various proper action and processing according to a program stored in a read-only memory (ROM) 1302 or a program loaded from a storage part 1308 to a random access memory (RAM) 1303, for example, the central processing unit 1301 performs the methods described in the foregoing embodiments. The RAM 1303 further stores various programs and data required for a system operation. The CPU 1301, the ROM 1302, and the RAM 1303 are connected to each other through a bus 1304. An input/output (I/O) interface 1305 is also connected to the bus 1304.

The following components may be connected to the I/O interface 1305: an input part 1306, including a keyboard, a mouse, and the like; an output part 1307, including a cathode ray tube (CRT), a liquid crystal display (LCD), a speaker, and the like; a storage part 1308, including a hard disk, and the like; and a communication part 1309, including a network interface card such as a local area network (LAN) card and a modem. The communication part 1309 performs communication processing through a network such as the internet. A drive 1310 is also connected to the I/O interface 1305 according to a requirement. A removable medium 1311, such as a magnetic disk, an optical disc, a magneto-optical disk, or a semiconductor memory, is installed on the drive 1310 according to a requirement, so that a computer program read from the removable medium 1311 is installed into the storage part 1308 according to a requirement.

Particularly, according to an embodiment of this application, a process described above with reference to the flowchart may be implemented as a computer software program. For example, an embodiment of this application includes a computer program product, including a computer program carried in a computer-readable medium, and the computer program is configured for performing the methods shown in the flowchart. In such an embodiment, the computer program may be downloaded and installed from a network through the communication part 1309 and/or installed from the removable medium 1311. When the computer program is executed by the central processing unit (CPU) 1301, various functions limited in the system of this application are performed.

The computer-readable medium shown in the embodiments of this application may be a computer-readable signal medium or a computer-readable storage medium, or any combination thereof. The computer-readable storage medium may be, for example, but is not limited to an electric, magnetic, optical, electromagnetic, infrared, or semiconductor system, apparatus, or device, or any combination thereof. A more specific example of the computer-readable storage medium may include, but is not limited to: an electrical connection having one or more wires, a portable computer disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any suitable combination thereof. In this application, the computer-readable storage medium may be any tangible medium including or storing the computer program, and the computer program may be used by an instruction execution system, an apparatus, or a device, or be used in combination with the instruction execution system, the apparatus, or the device. However, in this application, the computer-readable signal medium may include a data signal propagated in a baseband or propagated as part of a carrier, where the data signal carries the computer-readable computer program. Such a propagated data signal may take a variety of forms, including but not limited to an electromagnetic signal, an optical signal, or any suitable combination thereof. The computer-readable signal medium may also be any computer-readable medium other than the computer-readable storage medium. The computer-readable medium may send, propagate, or transmit a program for use by or in combination with the instruction execution system, the apparatus, or the device. The computer program included in the computer-readable medium may be transmitted by using any suitable medium, including but not limited to a wireless medium, a wired medium, or the like, or any suitable combination thereof.

Flowcharts and block diagrams in the accompanying drawings show architectures, functions, and operations that may be implemented by a system, a method, and the computer program product according to various embodiments of this application. Each block in the flowcharts or the block diagrams may represent a module, a program segment, or a part of code. The foregoing module, the foregoing program segment, or the part of code includes one or more executable instructions configured for implementing specified logic functions. In some implementations used as substitutes, functions marked in the blocks may also occur in a sequence different from that marked in the accompanying drawings. For example, two consecutive blocks may be executed in parallel, and may sometimes be executed in a reverse sequence, depending on a function involved. Each block in the block diagrams or the flowcharts, and combinations of the blocks in the block diagrams or flowcharts may be implemented by using a dedicated hardware-based system that performs a specified function or operation, or may be implemented by using a combination of dedicated hardware and the computer program.

Related units described in the embodiments of this application may be implemented in a software manner, or may be implemented in a hardware manner, or the described units may be disposed in a processor. Names of these units do not constitute limitations on these units in some cases.

In another aspect, this application further provides a computer-readable medium. The computer-readable medium may be included in the electronic device described in the foregoing embodiments; or the computer-readable medium may exist alone, and is not assembled into the electronic device. One or more computer programs are carried in the computer-readable medium, and when the foregoing one or more computer programs are executed by the electronic device, the electronic device is enabled to implement the methods described in the foregoing embodiments.

Although several modules or units of the device that are configured to perform an action are mentioned in the foregoing detailed descriptions, such division is not mandatory. In fact, according to implementations of this application, features and functions of two or more modules or units described above may be specific in one module or unit. On the contrary, a feature and a function of one module or one unit described above may be further divided into and be specific in a plurality of modules or units.

Based on the descriptions of the foregoing implementations, a person skilled in the art can easily understand that, exemplary implementations described herein may be implemented by software, or may be implemented by combining software with necessary hardware. Therefore, the technical solutions according to the implementations of this application may be implemented in a form of a software product. The software product may be stored in a non-volatile storage medium (which may be a CD-ROM, a USB flash drive, a removable hard disk, or the like) or in a network, and includes several instructions, so that the electronic device performs the methods according to the implementations of this application.

For example, the electronic device may be a residential gateway, and the residential gateway may perform the wireline access-based congestion processing method shown in FIG. 3. For another example, the electronic device may be a wireline access gateway device, and the wireline access gateway device may perform the wireline access-based congestion processing method shown in FIG. 4.

A person skilled in the art can easily figure out another implementation solution of this application after considering this specification and practicing the implementations that are disclosed herein. This application is intended to cover any variations, functions, or adaptive changes of this application. These variations, functions, or adaptive changes comply with general principles of this application, and include common knowledge or a commonly used technical means in the technical field that is not disclosed in this application.

This application is not limited to the precise structures described above and shown in the accompanying drawings, and various modifications and changes can be made without departing from the scope of this application. The scope of this application is limited only by the appended claims.

What is claimed is:

1. A wireline access-based congestion processing method performed by a computer device acting as a residential gateway between a service processing device and a wireline access gateway device, and the congestion processing method comprising:
establishing a protocol data unit PDU session with a core network element through the wireline access gateway device;
monitoring a service data packet that is transmitted between the service processing device and a service server based on the PDU session; and
performing congestion marking processing in accordance with a determination that the service data packet transmitted between the service processing device and the service server experiences congestion.

2. The method according to claim 1, wherein the performing congestion marking processing comprises at least one of the following manners:
performing explicit congestion notification ECN marking on an uplink service data packet if detecting that the uplink service data packet transmitted by the service processing device to the service server experiences congestion; and
performing ECN marking on a downlink service data packet if detecting that the downlink service data packet transmitted by the service server to the service processing device experiences congestion.

3. The method according to claim 1, wherein the congestion processing method further comprises:
transmitting congestion indication information to the wireline access gateway device in accordance with a determination that a service data packet transmitted between the service processing device and the residential gateway experiences congestion,
the congestion indication information being configured for indicating congestion information of the service data packet transmitted between the service processing device and the residential gateway.

4. The method according to claim 3, wherein the transmitting congestion indication information to the wireline access gateway device comprises:
transmitting the congestion indication information to the wireline access gateway device based on a wireline access control plane protocol between the residential gateway and the wireline access gateway device; or
transmitting the congestion indication information to the wireline access gateway device through a user plane transmission channel between the residential gateway and the wireline access gateway device.

5. The method according to claim 4, wherein the transmitting the congestion indication information to the wireline access gateway device through a user plane transmission channel between the residential gateway and the wireline access gateway device comprises:
transmitting, through the user plane transmission channel between the residential gateway and the wireline access gateway device, a data packet configured for indicating that the service data packet transmitted between the service processing device and the residential gateway experiences congestion to the wireline access gateway device; or
adding a flag bit configured for indicating that the service data packet transmitted between the service processing device and the residential gateway experiences congestion to the data packet that is transmitted to the wireline access gateway device, and transmitting, through the user plane transmission channel between the residential gateway and the wireline access gateway device, the data packet to which the flag bit is added to the wireline access gateway device.

6. The method according to claim 1, wherein the performing congestion marking processing in accordance with a determination that the service data packet transmitted between the service processing device and the service server experiences congestion comprises:
performing congestion marking processing on the service data packet transmitted between the service processing device and the service server through a low latency, low loss, and scalable throughput L4S technology in accordance with a determination that the service data packet transmitted between the service processing device and the service server experiences congestion.

7. The method according to claim 1, wherein the residential gateway comprises at least one of a 5G residential gateway and a fixed network-residential gateway.

8. A wireline access-based congestion processing method performed by a computer device acting as a wireline access gateway device connected to a residential gateway, the residential gateway being connected to a service processing device, and the congestion processing method comprising:
establishing a PDU session between the residential gateway and a core network element based on a PDU session establishment request transmitted by the residential gateway;
monitoring a service data packet that is transmitted between the service processing device and a service server based on the PDU session; and
performing congestion marking processing in accordance with a determination that the service data packet transmitted between the service processing device and the service server experiences congestion.

9. The method according to claim 8, wherein the performing congestion marking processing comprises at least one of the following manners:
performing ECN marking on an uplink service data packet if detecting that the uplink service data packet transmitted by the service processing device to the service server experiences congestion; and
performing ECN marking on a downlink service data packet if detecting that the downlink service data packet transmitted by the service server to the service processing device experiences congestion.

10. The method according to claim 8, wherein the congestion processing method further comprises:
obtaining congestion information of the service data packet transmitted between the service processing device and the service server, and transmitting the congestion information to the core network element.

11. The method according to claim 10, wherein the obtaining congestion information of the service data packet transmitted between the service processing device and the service server comprises at least one of the following manners:
detecting congestion information of a service data packet relayed by the wireline access gateway device;
generating the congestion information according to a wireline access parameter; and
receiving congestion indication information reported by the residential gateway, wherein the congestion indication information is configured for indicating congestion information of a service data packet transmitted between the service processing device and the residential gateway.

12. The method according to claim 11, wherein the detecting congestion information of a service data packet relayed by the wireline access gateway device comprises:
detecting a traffic control queue profile defined by a descriptor field of the service data packet relayed by the wireline access gateway device, to detect the congestion information of the service data packet relayed by the wireline access gateway device.

13. The method according to claim 12, wherein the traffic control queue profile is configured for defining and controlling a parameter set of network traffic, and the parameter set comprises at least one of bandwidth utilization and a latency of a queue to which the service data packet belongs; and
the detecting a traffic control queue profile defined by a descriptor field of the service data packet relayed by the wireline access gateway device, to detect the congestion information of the service data packet relayed by the wireline access gateway device comprises at least one of the following:
determining that congestion exists in a network path corresponding to the queue to which the service data packet belongs if the bandwidth utilization of the queue to which the service data packet belongs is greater than bandwidth utilization of another queue within preset duration; and
determining that congestion exits in the network path corresponding to the queue to which the service data packet belongs if the latency of the queue to which the service data packet belongs is greater than a preset latency.

14. The method according to claim 11, wherein the generating the congestion information according to a wireline access parameter comprises:
generating the congestion information according to a residential gateway level wireline access characteristic of the wireline access gateway device.

15. The method according to claim 14, wherein the residential gateway level wireline access characteristic is configured for describing a wired link of the wireline access gateway device, and comprises at least one of the following: a transmission rate, a jitter characteristic, and a packet loss rate that are supported by the wired link; and
the generating the congestion information according to a residential gateway level wireline access characteristic of the wireline access gateway device comprises at least one of the following:
generating the congestion information if the transmission rate of the wired link is less than a preset rate;
generating the congestion information if jitter of the wired link is greater than preset duration; and
generating the congestion information if the packet loss rate of the wired link is greater than a preset packet loss rate.

16. The method according to claim 11, wherein the generating the congestion information according to a wireline access parameter comprises:
generating the congestion information according to a quantity of buffers.

17. The method according to claim 16, wherein the generating the congestion information according to a quantity of buffers comprises:
generating the congestion information if the quantity of buffers is greater than a preset quantity.

18. The method according to claim 11, wherein the generating the congestion information according to a wireline access parameter comprises:
generating the congestion information according to a length of the queue to which the service data packet belongs.

19. The method according to claim 8, wherein the performing congestion marking processing in accordance with a determination that the service data packet transmitted between the service processing device and the service server experiences congestion comprises:
performing, through an L4S technology, congestion marking processing on the service data packet transmitted between the service processing device and the service server in accordance with a determination that the service data packet transmitted between the service processing device and the service server experiences congestion.

20. The method according to claim 8, wherein the congestion processing method further comprises:
obtaining QoS profile information configured for performing an L4S technology on the service data packet; and
performing QoS processing in process of transmitting the service data packet between the service processing device and the service server according to the QoS profile information.
